(19) United States
(12) Patent Application Publication
(10) Pub. No.: US 2017/0183050 A1
(43) Pub. Date: Jun. 29, 2017

(54) BIKE SADDLE WITH ILLUMINATION-CONTROLLED LIGHTS

(71) Applicant: URBS INTERNATIONAL L.L.C., New Castle County, DE (US)

(72) Inventor: Hung-Tien Ling, Taipei City (TW)

(21) Appl. No.: 15/000,301

(22) Filed: Jan. 19, 2016

(30) Foreign Application Priority Data
Dec. 28, 2015 (TW) 104220930

(51) Int. Cl. B62J 3/00; H05B 37/02; B62J 1/28; F21V 23/02; F21V 21/08; F21V 15/01; F21V 23/00

(52) U.S. Cl. CPC B62J 3/00; F21V 15/01; H05B 37/0218; F21V 23/003; F21V 23/02; F21V 21/0808; B62J 1/28

(57) ABSTRACT

An alarm light assembly for a bike saddle includes at least one lighting unit, a light sensor unit, an electric energy unit, a control unit, and a threshold-signal storage unit. The light sensor unit detects surrounding brightness and generates a surrounding brightness signal. The control unit receives and compares the surrounding brightness signal with a threshold signal such that when the surrounding brightness signal is less than the threshold signal, a driving signal is generated to drive the lighting unit to generate alarm lighting.

### BACKGROUND OF THE INVENTION

1. Field of the Invention

The present invention relates to a safety design of saddles, and in particular to a bike saddle with illumination-controlled lights, which automatically detects surrounding brightness and, in response thereto, generates an alarm lighting.

2. The Related Arts

Sports cycling is prevailing today. Various accessories are available for use and professional applications. Concerning bicycle accessories regarding cycling safety, various alarm lights having different configurations and functions have been proposed and developed to improve cycling safety of the cyclers and are generally structured for mounting to front, rear, and lateral sides of bicycles, and some are provided for wearing on the body or head of a user. However, such alarm lights requires manual operations of the cyclers to switch the on/off states thereof. This is inconvenient in operation of the cyclers.

Further, among all the different types of safety-concerned accessories for bicycles, none is designed for bicycle saddles. It is noticed that, considering the entirety of a bicycle, the saddle presents a visual attention point from the rear and/or lateral sides when the bicycle is ridden by a cycler. However, among all the bicycle accessories available in the market today, there is no alarm device that is developed for the bicycle saddles.

### SUMMARY OF THE INVENTION

Thus, in view of the above drawbacks of bicycle safety alarm in association with saddles, the primary object of the present invention is to provide a bike saddle with illumination-controlled lights and to allow the lighting unit to achieve an automatic alarming function according to the surrounding brightness.

The technical solution adopted in the present invention to overcome such known issues is that an alarm light assembly is provided and coupled to a saddle. The alarm light assembly comprises at least one lighting unit, a light sensor unit, an electric energy unit, a control unit, and a threshold-signal storage unit, wherein the light sensor unit detects surrounding brightness and/or illumination and, in response thereto, generates a surrounding brightness signal. The control unit receives and compares the surrounding brightness signal with a threshold signal such that when the surrounding brightness signal is less than the threshold signal, a driving signal drives the lighting unit to generate alarm lighting.

In this arrangement, the alarm light assembly is mounted to a circumferential rim of the saddle and is covered by a protective plate.

In this arrangement, the alarm light assembly is attached by an adhesive layer to a surface of the circumferential rim of the saddle.

In this arrangement, the alarm light assembly comprises an insertion terminal that is insertable into a fitting slot formed in the saddle.

In this arrangement, the alarm light assembly is embedded in a recess formed in the circumferential rim of the saddle.

In this arrangement, the alarm light assembly is coupled by a fastening member to an extension section extending from the saddle.

The efficacy is that the present invention automatically detects the surrounding brightness of site where it is located and, in response thereto, generates a surrounding brightness signal. When the surrounding brightness signal is less than a threshold signal, the control unit drives the lighting units to generate alarm lighting. With the arrangement of the present invention, even when a bicycle is moving through for example a tunnel or is at a dark environment, alarm lighting is automatically generated and emitted to achieve an affect of alarm or warning for improving the safety of a bicycle rider.

Further, the alarm light assembly of the present invention can be installed in various ways for coupling, such as being embedded, being externally attached, or being inserted, to a saddle, so that the installation can be done easily by a user.

### BRIEF DESCRIPTION OF THE DRAWINGS

The present invention will be apparent to those skilled in the art by reading the following description of preferred embodiments of the present invention, with reference to the attached drawings, in which:

FIG. 1 is a perspective view showing a first embodiment of the present invention;

FIG. 2 is a control circuit diagram of the present invention;

FIG. 3 is a perspective view showing a second embodiment of the present invention;

FIG. 4 is a perspective view showing a third embodiment of the present invention;

FIG. 5 is a perspective view showing a fourth embodiment of the present invention;

FIG. 6 is a perspective view showing a fifth embodiment of the present invention; and

FIG. 7 is a perspective view showing a sixth embodiment of the present invention.

### DETAILED DESCRIPTION OF THE PREFERRED EMBODIMENTS

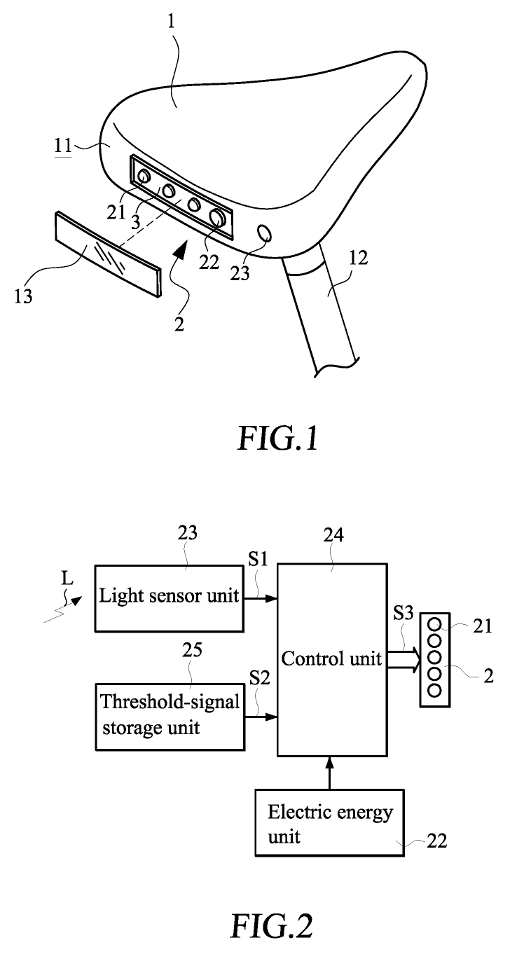

With reference to the drawings and in particular to FIG. 1, a perspective view is given to illustrate a first embodiment of the present invention. As shown in the drawing, a saddle 1 is formed with a circumferential rim 11, and the saddle 1 has a bottom to which a bar 12 is mounted.

In the design according to the present invention, the circumferential rim 11 of the saddle 1 is provided with an alarm light assembly 2, which is automatically lit on according to a surrounding brightness of a current location when a cycler is riding a bicycle so as to improve cycling safety. The saddle 1 is made of known materials, such as soft foaming materials, polymer materials, leather materials, or waterproof materials. The alarm light assembly 2 can be integrally combined with the structure of the saddle 1 and covered by a protective plate 13.

Referring additionally to FIG. 2, the alarm light assembly 2 comprises a plurality of lighting units 21 arranged on and distributed along the circumferential rim 11 of the saddle 1 and is mounted to a circuit carrier board 3. An electric energy unit 22 is mounted on the circuit carrier board 3 and connected to the alarm light assembly 21 to supply electric energy to circuit components of the alarm light assembly 2.

A light sensor unit 23 is mounted on the circuit carrier board 3 or alternatively mounted to a location on the circumferential rim 11 of the saddle 1 or any other sites suitable for detecting surrounding brightness in order to detect a surrounding brightness L and then generate a surrounding brightness signal S1.

A control unit 24 is connected to the lighting units 21 and the light sensor unit 23 to receive the surrounding brightness signal S1 generated by the light sensor unit 23. A threshold-signal storage unit 25 is connected to the control unit 24 to supply a threshold signal S2 to the control unit 24.

The control unit 24 compares the surrounding brightness signal S1 generated by the light sensor unit 23 with the threshold signal S2 such that when the surrounding brightness signal S1 is less than the threshold signal S2, a driving signal S3 is generated from the control unit 24 to drive the lighting units 21 to generate alarm lighting.

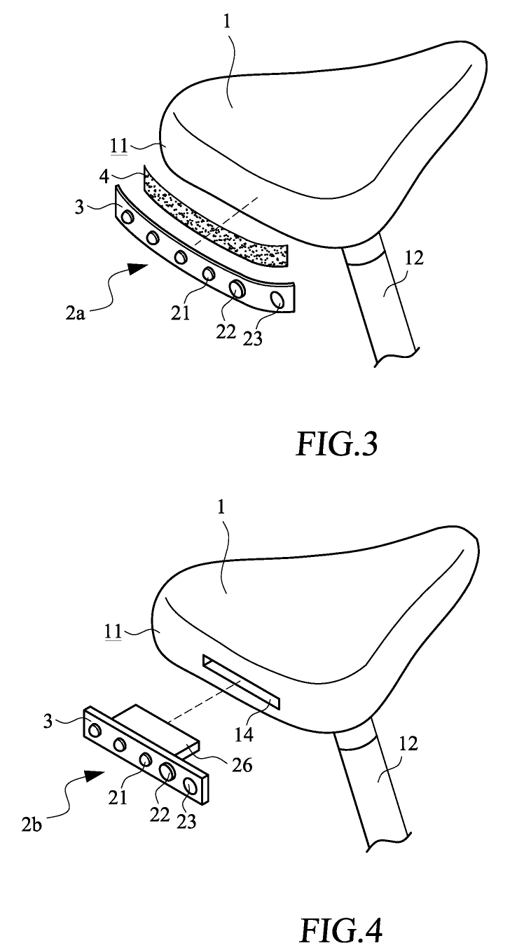

Referring to FIG. 3, a perspective view is given to illustrate a second embodiment of the present invention. Most of the components/parts of the instant embodiment are similar to the counterparts of the first embodiment and thus, similar components/parts are designated with the same reference numeral for consistency. In the instant embodiment, the alarm light assembly 2a similarly comprises lighting units 21, an electric energy unit 22, a light sensor unit 23, and a circuit carrier board 3, and the circuit carrier board 3 is attached by means of an adhesive layer 4 to a surface of a circumferential rim 11 of a saddle 1. Thus, a user may mount the alarm light assembly 2a to an ordinary saddle 1 as desired to similarly achieve an alarm function.

Referring to FIG. 4, a perspective view is given to illustrate a third embodiment of the present invention. In the instant embodiment, an alarm light assembly 2b comprises an insertion terminal 26 extending therefrom for insertion into a fitting slot 14 formed in a circumferential rim 11 of a saddle 1 t to similarly achieve an alarm function.

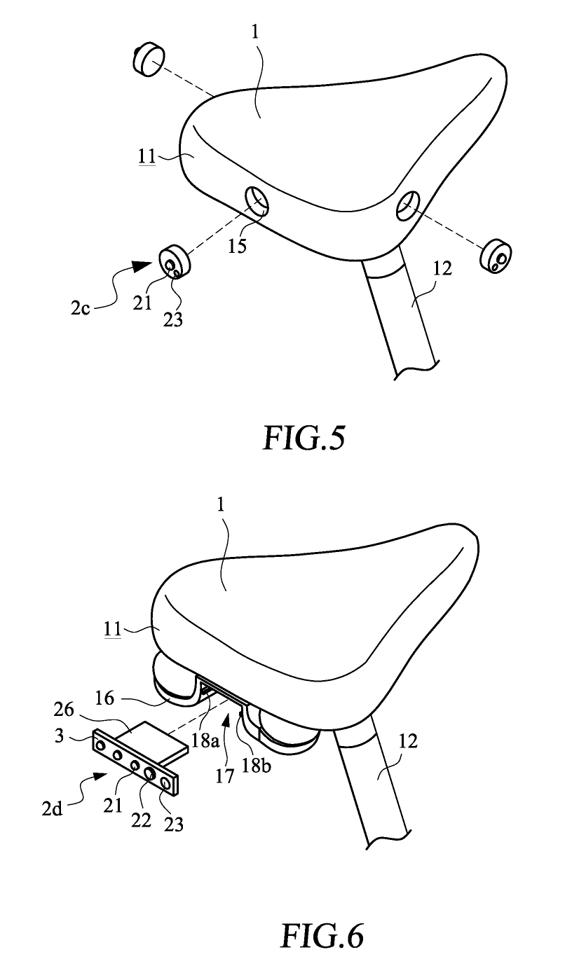

Referring to FIG. 5, a perspective view is given to illustrate a fourth embodiment of the present invention. In the instant embodiment, an alarm light assembly 2c is made as a unitary structure in the form of a circular configuration, a rectangular configuration, or other shapes and is embedded in a recess 15 formed in the circumferential rim 11 of the saddle 1 to similarly achieve an alarm function.

Referring to FIG. 6, a perspective view is given to illustrate a fifth embodiment of the present invention. In the instant embodiment, an alarm light assembly 2d comprises an insertion terminal 26 extending therefrom for insertion into a fitting slot 17 formed in a base 16 of a saddle 1. The fitting slot 17 comprises and is delimited by rails 18a, 18b formed on left and right sides of the base to be opposite to each other so as to similarly achieve an alarm function.

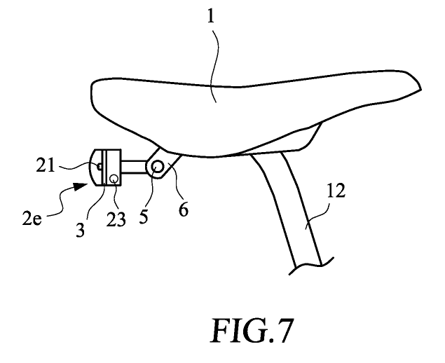

Referring to FIG. 7, a perspective view is given to illustrate a sixth embodiment of the present invention. In the instant embodiment, an alarm light assembly 2e is coupled, by means of a fastening member 5 (such as a bolt or a buckle), to an extension section 6 extending from a saddle 1 to similarly achieve an alarm function.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A bike saddle provided with an alarm light assembly mounted on a circumferential rim of the saddle, the alarm light assembly comprising:
at least one lighting unit mounted on a circuit carrier board;
an electric energy unit connected to the alarm light assembly to supply electric energy to the alarm light assembly;
a light sensor unit operable to detect a surrounding brightness and generate a surrounding brightness signal;
a control unit connected to the lighting unit and the light sensor unit to receive the surrounding brightness signal generated by the light sensor unit; and
a threshold-signal storage unit connected to the control unit to supply a threshold signal to the control unit;
wherein the control unit compares the surrounding brightness signal generated by the light sensor unit with the threshold signal such that when the surrounding brightness signal is less than the threshold signal, a driving signal is generated to drive the lighting unit to generate an alarm lighting.

2. The bike saddle as claimed in claim 1, wherein the alarm light assembly is mounted to the circumferential rim of the saddle and a protective plate is provided to cover the alarm light assembly.

3. The bike saddle as claimed in claim 1, wherein the alarm light assembly is attached by an adhesive layer to a surface of the circumferential rim of the saddle.

4. The bike saddle as claimed in claim 1, wherein the alarm light assembly comprises an insertion terminal that is insertable into a fitting slot formed in the saddle.

5. The bike saddle as claimed in claim 1, wherein the alarm light assembly is embedded in a recess formed in the circumferential rim of the saddle.

6. The bike saddle as claimed in claim 1, wherein the alarm light assembly is coupled by a fastening member to an extension section extending from the saddle.
